(19) United States
(12) Patent Application Publication
(10) Pub. No.: US 2026/0178688 A1
(43) Pub. Date: Jun. 25, 2026

(54) DISCRETE COSINE TRANSFORM PROCESSING DEVICE AND DISCRETE COSINE TRANSFORM PROCESSING METHOD

(71) Applicant: SigmaStar Technology Ltd., Xiamen (CN)

(72) Inventors: Yu LIANG, Shanghai (CN); Xue ZHANG, Shanghai (CN)

(21) Appl. No.: 19/399,912

(22) Filed: Nov. 25, 2025

(30) Foreign Application Priority Data
Dec. 19, 2024 (CN) 202411885438.2

(51) Int. Cl. G06F 17/14; G06F 7/544; G06F 17/16

(52) U.S. Cl. CPC G06F 17/147; G06F 7/5443; G06F 17/16

(57) ABSTRACT

A discrete cosine transform processing device includes an adder, a register, multiple multiply-accumulate operation circuits, an accumulator, an operation control circuit and an output circuit. The adder processes first input data based on a first permutation matrix to generate second input data. The register stores an operation matrix. The operation control circuit configures the multiply-accumulate operation circuits and the accumulator based on a matrix multiplication operation corresponding to a unit dimension, such that the operation matrix and the second input data are multiplied and accumulated by the multiply-accumulate operation circuits and the accumulator to generate a first operation result. The output circuit processes the first operation result based on a second permutation matrix to generate a second operation result, wherein the first permutation matrix, the operation matrix, and the second permutation matrix are derived from decomposition of a discrete cosine transform matrix.

This application claims the benefit of China application Serial No. CN202411885438.2, filed on Dec. 19, 2025, the subject matter of which is incorporated herein by reference.

### BACKGROUND OF THE INVENTION

### Field of the Invention

The present application relates to a discrete cosine transform processing device, and more particularly to a discrete cosine transform processing device and method able to utilize a low-dimension matrix multiplication operation to perform discrete cosine transform.

### Description of the Related Art

Discrete cosine transform is frequently applied in the field of image processing or video encoding/decoding. In the prior art, a large amount of multipliers are used to perform matrix multiplication operations in discrete cosine transform, resulting in immense costs of hardware implementation, as well as an overly high overall computation amount caused by execution of multiple rounds of multiplication operations. On the other hand, in the prior art, there is another type of architecture that simplifies a computation amount by first utilizing the odd-even symmetry property in a discrete cosine transform matrix. However, multiple multipliers capable of performing matrix multiplication operations of different dimensions need to be configured in advance for such architecture. In case of any application changes (for example, an increase in the number of dimensions of input data), the hardware structure of the architecture above cannot be flexibly adjusted, leading to reduced overall resource utilization efficiency.

### SUMMARY OF THE INVENTION

In some embodiments, it is an object of the present application to provide a discrete cosine transform processing device and method to perform discrete cosine transform by utilizing low-dimension matrix multiplication operations so as to improve the issues of the prior art.

In some embodiments, a discrete cosine transform processing device includes an adder, a register, a plurality of multiply-accumulate operation circuits, an accumulator, an operation control circuit and an output circuit. The adder processes first input data based on a first permutation matrix to generate second input data. The register stores an operation matrix. The operation control circuit configures the plurality of multiply-accumulate operation circuits and the accumulator according to a matrix multiplication operation corresponding to a unit dimension, such that the operation matrix and the second input data are multiplied and accumulated by the plurality of multiply-accumulate operation circuits and the accumulator to generate a first operation result. The output circuit processes the first operation result based on a second permutation matrix to generate a second operation result, wherein the first permutation matrix, the operation matrix, and the second permutation matrix are derived from decomposition of a discrete cosine transform matrix.

In some embodiments, a discrete cosine transform processing method performed by a processing device includes operations of: processing first input data based on a first permutation matrix to generate second input data; configuring a plurality of multiply-accumulate operation circuits and an accumulator in the processing device according to a matrix multiplication operation corresponding to a unit dimension such that an operation matrix and the second input data are multiplied and accumulated by the multiply-accumulate operation circuits and the accumulator to generate a first operation result; and processing the first operation result based on a second permutation matrix to generate a second operation result, wherein the first permutation matrix, the operation matrix and the second permutation matrix are derived from decomposition of a discrete cosine transform matrix.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 is a schematic diagram of a discrete cosine transform processing device 100 according to some embodiments of the present application.

FIG. 2 is a flowchart of related operations of the discrete cosine transform processing device 100 in FIG. 1 according to some embodiments of the present application.

FIG. 3 is a flowchart of two operations in FIG. 2 according to some embodiments of the present application.

FIG. 4 is a schematic diagram of the multiply-accumulate operation circuit in FIG. 1 according to some embodiments of the present application.

FIG. 5 is a flowchart of two operations in FIG. 2 according to some embodiments of the present application.

FIG. 6 is a flowchart of a discrete cosine transform processing method according to some embodiments of the present application.

### DETAILED DESCRIPTION OF THE INVENTION

All terms used in the literature have commonly recognized meanings. Definitions of the terms in commonly used dictionaries and examples discussed in the disclosure of the present application are merely exemplary, and are not to be construed as limitations to the scope or the meanings of the present application. Similarly, the present application is not limited to the embodiments enumerated in the description of the application.

The term “coupled” or “connected” used in the literature refers to two or multiple elements being directly and physically or electrically in contact with each other, or indirectly and physically or electrically in contact with each other, and may also refer to two or more elements operating or acting with each other. As given in the literature, the term “circuit” may be a device connected by at least one transistor and/or at least one active element by a predetermined means so as to process signals.

Some embodiments of the present application relate to a processing device and method based on discrete cosine transform (DCT). Discrete cosine transform is common in applications such as image processing and video encoding/decoding. For example, discrete cosine transform may be used for compression, noise reduction, feature extraction and image reconstruction of images or videos. Thus, the processing device and method provided according to some embodiments of the present application may also be used in the application fields above; however, the present application is not limited to such examples.

To better understand the embodiments of the present application, mathematical concepts of discrete cosine transform are described in brief below, and related operation and configuration details of the embodiments of the present application are also to be described with the accompanying drawings.

To express in the form of a matrix, a mathematic function of discrete cosine transform may be expressed as equation (1) below:

$$Y = D \times X = [ \begin{matrix}y ( 0 ) \\ y ( 1 ) \\ ⋮ \\ y ( N - 1 )\end{matrix} ] = [ \begin{matrix}{D}_{0 , 0} & {D}_{0 , 1} & … & {D}_{0 , N - 1} \\ {D}_{1 , 0} & {D}_{1 , 1} & … & {D}_{1 , N - 1} \\ ⋮ & ⋮ & ⋱ & ⋮ \\ {D}_{N - 1 , 0} & {D}_{N - 1 , 1} & … & {D}_{N - 1 , N - 1}\end{matrix} ] [ \begin{matrix}x ( 0 ) \\ x ( 1 ) \\ ⋮ \\ x ( N - 1 )\end{matrix} ] \qquad ( 1 )$$

In equation (1), Y is output data having undergone discrete cosine transform processing, X is input data, and D is a discrete cosine transform matrix. On the basis of the mathematical function of the discrete cosine transform matrix, the discrete cosine transform matrix D may be further expressed by an equation below through derivation:

$$\begin{matrix}D = [ \begin{matrix}{D}_{0 , 0} & {D}_{0 , 1} & … & {D}_{0 , N - 1} \\ {D}_{1 , 0} & {D}_{1 , 1} & … & {D}_{1 , N - 1} \\ ⋮ & ⋮ & ⋱ & ⋮ \\ {D}_{N - 1 , 0} & {D}_{N - 1 , 1} & … & {D}_{N - 1 , N - 1}\end{matrix} ] \\ = \sqrt{\frac{N}{2}} [ \begin{matrix}\frac{\sqrt{2}}{2} cos 0 & \frac{\sqrt{2}}{2} cos 0 & … & \frac{\sqrt{2}}{2} cos 0 \\ cos \frac{π}{2 N} & cos \frac{3 π}{2 N} & … & cos \frac{( 2 N - 1 ) π}{2 N} \\ ⋮ & ⋮ & ⋱ & ⋮ \\ cos \frac{( N - 1 ) π}{2 N} & cos \frac{( N - 1 ) 3 π}{2 N} & … & cos \frac{( 2 N - 1 ) ( N - 1 ) π}{2 N}\end{matrix} ]\end{matrix}$$

In some embodiments, the discrete cosine transform processing device and method provided by the present application perform discrete cosine transform by means of decomposing the discrete cosine transform matrix D above, so as to enhance hardware processing efficiency and resource utilization efficiency of the overall system with use of the same computation ability, thereby bringing significant improvement in technical fields of image processing and video encoding/decoding.

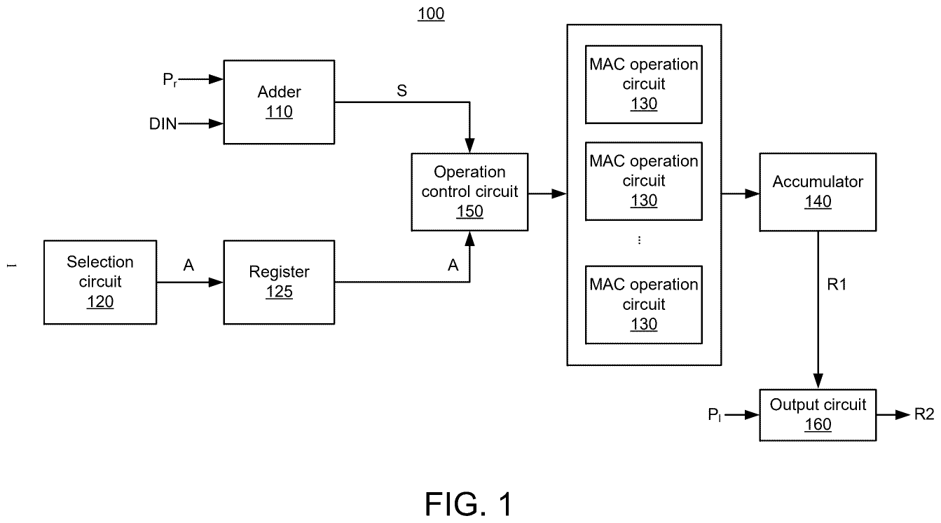

FIG. 1 shows a schematic diagram of a discrete cosine transform processing device 100 according to some embodiments of the present application. In some embodiments, the discrete cosine transform processing device 100 may be implemented by hardware, for example, the discrete cosine transform processing device 100 may be implemented as an integrated circuit.

The discrete cosine transform processing device 100 includes an adder 110, a selection circuit 120, a register 125, a plurality of multiply-accumulate (MAC) operation circuits 130, an accumulator 140, an operation control circuit 150 and an output circuit 160.

The adder 110 processes input data DIN based on a permutation matrix Pᵣ to generate input data S. In some embodiments, all elements in the permutation matrix Pᵣ can be valued as only 0, 1, or −1. Thus, addition and subtraction operations may be used to implement operations of the permutation matrix Pᵣ to process the input data DIN, and circuits such as multipliers are not needed for operations of the permutation matrix Pᵣ for processing the input data DIN, thereby reducing hardware costs.

The selection circuit 120 selects a corresponding operation matrix A from a plurality of pre-configured operation matrices according to a current processing requirement, and stores related coefficients of this operation matrix A to the register 125. For example, the selection circuit 120 may select the operation matrix A above based on the number of dimensions of the input data DIN.

The operation control circuit 150 configures the plurality of multiply-accumulate operation circuits 130 and the accumulator 140 according to a matrix multiplication operation corresponding to a unit dimension, such that the operation matrix A and the input data S are multiplied and accumulated by the plurality of multiply-accumulate operation circuits 130 and the accumulator 140 to generate an operation result R1. In some embodiments, the matrix multiplication operation corresponding to the unit dimension is determined based on a basic circuit unit corresponding to the multiply-accumulate operation circuits 130.

The output circuit 160 processes the operation result R1 based on a permutation matrix Pₗ to generate an operation result R2. In some embodiments, the operation result R2 may be an output of the input data DIN undergone discrete cosine transform processing. For example, the input data DIN is equivalent to the input data X in equation (1), and the operation result R2 is equivalent to the output Y in equation (1). In some embodiments, all elements in the permutation matrix Pₗ can be valued as only 0 or 1. Thus, addition and subtraction operations may be used to implement operations of the permutation matrix Pₗ, and circuits such as multipliers are not need for performing operations of the permutation matrix Pᵣ, thereby reducing hardware costs. In some embodiments, the output circuit 160 may be an adder, which is configured to equivalently multiply the permutation matrix Pₗ and the operation result R1 by performing addition and subtraction operations to generate the operation result R2. In some embodiments, the output circuit 160 includes a buffer, which is configured to adjust an output sequence of related elements in the operation result R1 based on corresponding elements in the permutation matrix Pₗ, and output the operation result R1 as the operation result R2 based on the output sequence.

In some embodiments, the permutation matrix Pᵣ, the permutation matrix Pₗ and the plurality of operation matrices A are determined in an offline manner. In some embodiments, the operation matrices A, the permutation matrix Pᵣ and the permutation matrix Pₗ may be derived from decomposition of the discrete cosine transform matrix D in equation (1). For example, related information of the permutation matrix Pᵣ, the permutation matrix Pₗ and the plurality of operation matrices A may be determined in advance by mathematical simulation software (for example but not limited to, MATLAB) executed on a computer, and the information is then stored in advance in the discrete cosine transform processing device 100.

An embodiment, where related information of the permutation matrix Pᵣ, the permutation matrix Pₗ and the plurality of operation matrices A are generated in an offline manner, is described below. As described above, the operation matrices A, the permutation matrix Pᵣ and the permutation matrix Pₗ may be derived from decomposition of the discrete cosine transform matrix D in equation (1). More specifically, a product of the operation matrices A, the permutation matrix Pᵣ, the permutation matrix Pₗ is the discrete cosine transform matrix D, and may be expressed as equation (2) below:

$$D = {P}_{l} \times A \times {P}_{r} \qquad ( 2 )$$

Refer to the attachment at the end of the text. The attachment is an exemplary algorithm for determining operation matrices A, the permutation matrix Pᵣ, the permutation matrix Pₗ according to an embodiment of the present application, and may be executed by, for example but not limited to, the mathematical simulation software above. This algorithm primarily includes several steps. The first step is initialization to set each of the permutation matrix Pᵣ and the permutation matrix Pₗ as a zero matrix having dimensions N×N, where N is the number of dimensions of the input data DIN. The second step is a first-tier circulation to set some elements in the permutation matrix Pᵣ and the permutation matrix Pₗ by values i to L−1, where L is the unit dimension above. The third step is a second-tier circulation to fill in remaining elements in the permutation matrix Pᵣ and the permutation matrix Pₗ sequentially with m from log₂(L) to log₂(N)−1, then i from 0 to n−1, and lastly j from 0 to n−1. The fourth step is to set the operation matrix A on the basis of an inverse matrix of the permutation matrix Pᵣ, an inverse matrix of the permutation matrix Pₗ and the discrete cosine matrix D.

In some embodiments, the discrete cosine transform processing device 100 may complete the discrete cosine transform operation in equation (1) by equation (2), and an operation process thereof may be sequentially deduced as equation (3) below:

$$Y = D \times X = {P}_{l} \times A \times {P}_{r} \times X = {P}_{l} \times A \times S = {P}_{l} \times T \qquad ( 3 )$$

In equation (3), Y is equivalent to the operation result R2, X is equivalent to the input data DIN, S is the input data S (which is a product of a permutation matrix Pᵣ and the input data DIN), and T is a product of the operation matrix A and the input data S (wherein the product is equivalent to the operation result R1). Operation and configuration details are described with the other accompanying drawings below.

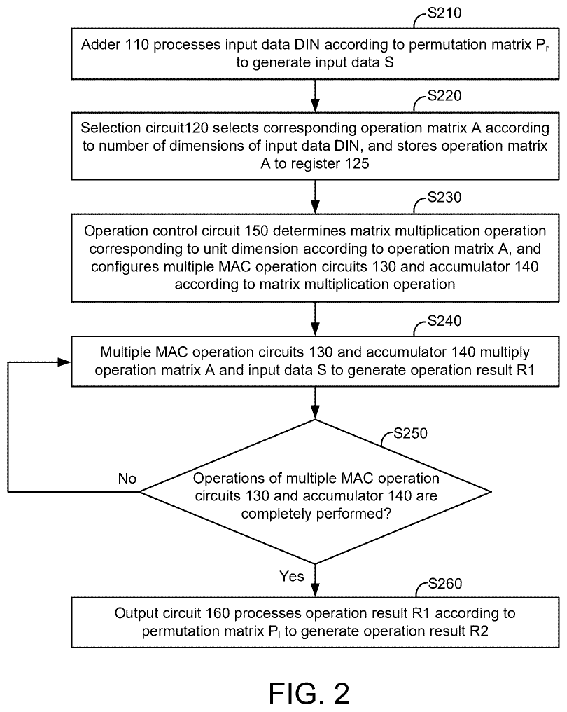

FIG. 2 shows a flowchart of related operations performed by the discrete cosine transform processing device 100 in FIG. 1 according to some embodiments of the present application. In operation S210, the adder 110 processes input data DIN based on the permutation matrix Pᵣ to generate input data S. In operation S220, the selection circuit 120 selects the corresponding operation matrix A based on the number of dimensions of the input data DIN, and stores the operation matrix A to the register 125. In operation S230, the operation control circuit 150 determines a matrix multiplication operation corresponding to the unit dimension based on the operation matrix A, and configures the plurality of multiply-accumulate operation circuits 130 and the accumulator 140 according to the matrix multiplication operation. In operation S240, the plurality of multiply-accumulate operation circuits 130 and the accumulator 140 multiply the operation matrix A and the input data S to generate the operation result R1. In operation S250, the control operation circuit 150 determines whether operations of the plurality of multiply-accumulate operation circuits 130 and the accumulator 140 are completely performed. If so, operation S260 is performed. If not, operation S240 is iterated. In operation S260, the output circuit 160 processes the operation result R1 based on the permutation matrix Pₗ to generate the operation result R2.

In some embodiments, the unit dimension is determined by a multiply-accumulate operation circuit, which is capable of performing matrix multiplication of a minimum dimension, among the plurality of multiply-accumulate operation circuits 130. For example, if each of the plurality of multiply-accumulate operation circuits 130 is implemented by a multiply-accumulate operation circuit capable of performing 2×2 matrix multiplication, the matrix multiplication operation corresponding to the unit dimension L (or the minimum dimension) is 2×2 matrix multiplication and the unit dimension is 2.

For example, if the number of dimensions of the input data DIN is 4 and the unit dimension L is 2, each of the plurality of multiply-accumulate operation circuits 130 utilizes a multiply-accumulate operation circuit capable of performing 2×2 matrix multiplication as a basic circuit unit. In this case, the input data DIN may be expressed as an equation below:

$$X = [ \begin{matrix}{x}_{11} & {x}_{12} & {x}_{13} & {x}_{14} \\ {x}_{21} & {x}_{22} & {x}_{23} & {x}_{24} \\ {x}_{31} & {x}_{32} & {x}_{33} & {x}_{34} \\ {x}_{41} & {x}_{42} & {x}_{43} & {x}_{44}\end{matrix} ]$$

Correspondingly, the discrete cosine transform matrix D may be expressed as an equation below:

$$D = [ \begin{matrix}{d}_{11} & {d}_{12} & {d}_{13} & {d}_{14} \\ {d}_{21} & {d}_{22} & {d}_{23} & {d}_{24} \\ {d}_{31} & {d}_{32} & {d}_{33} & {d}_{34} \\ {d}_{41} & {d}_{42} & {d}_{43} & {d}_{44}\end{matrix} ]$$

Further, based on the symmetry property of the discrete cosine transform matrix D, the discrete cosine transform matrix D in the equation above may be further re-expressed as an equation below:

$$D = [ \begin{matrix}{d}_{11} & {d}_{11} & {d}_{11} & {d}_{11} \\ {d}_{21} & {d}_{22} & - {d}_{22} & - {d}_{21} \\ {d}_{31} & {d}_{32} & {d}_{32} & {d}_{31} \\ {d}_{41} & {d}_{42} & - {d}_{42} & - {d}_{41}\end{matrix} ]$$

Based on the operations in the attachment, a following equation is derived from the operation matrix A, the permutation matrix Pᵣ and the permutation matrix Pₗ:

$$D = {P}_{l} \times A \times {P}_{r} = [ \begin{matrix}1 & 0 & 0 & 0 \\ 0 & 0 & 1 & 0 \\ 0 & 1 & 0 & 0 \\ 0 & 0 & 0 & 1\end{matrix} ] [ \begin{matrix}{d}_{11} & {d}_{11} & 0 & 0 \\ {d}_{31} & {d}_{32} & 0 & 0 \\ 0 & 0 & {d}_{22} & {d}_{21} \\ 0 & 0 & {d}_{42} & {d}_{41}\end{matrix} ] [ \begin{matrix}1 & 0 & 0 & 1 \\ 0 & 1 & 1 & 0 \\ 0 & 1 & - 1 & 0 \\ 1 & 0 & 0 & - 1\end{matrix} ]$$

Accordingly, in operation S210, the input data DIN may be processed based on the permutation matrix Pᵣ to generate input data S, and this may be expressed as an equation below:

$$S = {P}_{r} \times X = [ \begin{matrix}{s}_{11} & {s}_{12} & {s}_{13} & {s}_{14} \\ {s}_{21} & {s}_{22} & {s}_{23} & {s}_{24} \\ {s}_{31} & {s}_{32} & {s}_{33} & {s}_{34} \\ {s}_{41} & {s}_{42} & {s}_{43} & {s}_{44}\end{matrix} ] = [ \begin{matrix}1 & 0 & 0 & 1 \\ 0 & 1 & 1 & 0 \\ 0 & 1 & - 1 & 0 \\ 1 & 0 & 0 & - 1\end{matrix} ] [ \begin{matrix}{x}_{11} & {x}_{12} & {x}_{13} & {x}_{14} \\ {x}_{21} & {x}_{22} & {x}_{23} & {x}_{24} \\ {x}_{31} & {x}_{32} & {x}_{33} & {x}_{34} \\ {x}_{41} & {x}_{42} & {x}_{43} & {x}_{44}\end{matrix} ] = [ \begin{matrix}{x}_{11} + {x}_{41} & {x}_{12} + {x}_{42} & {x}_{13} + {x}_{43} & {x}_{14} + {x}_{44} \\ {x}_{21} + {x}_{31} & {x}_{22} + {x}_{32} & {x}_{23} + {x}_{33} & {x}_{24} + {x}_{34} \\ {x}_{21} - {x}_{31} & {x}_{22} - {x}_{32} & {x}_{23} - {x}_{33} & {x}_{24} - {x}_{34} \\ {x}_{11} - {x}_{41} & {x}_{12} - {x}_{42} & {x}_{13} - {x}_{43} & {x}_{14} - {x}_{44}\end{matrix} ]$$

It is known from the operation result above that, the mathematical operations in operation S210 involve merely addition and subtraction operations, and can thus be performed by the adder 110.

Next, the operation matrix A is further multiplied with the input data S to generate the operation result R1, which may be expressed as equation (4) below:

$$T = [ \begin{matrix}{t}_{11} & {t}_{12} & {t}_{13} & {t}_{14} \\ {t}_{21} & {t}_{22} & {t}_{23} & {t}_{24} \\ {t}_{31} & {t}_{32} & {t}_{33} & {t}_{34} \\ {t}_{41} & {t}_{42} & {t}_{43} & {t}_{44}\end{matrix} ] = A \times S = [ \begin{matrix}{d}_{11} & {d}_{11} & 0 & 0 \\ {d}_{31} & {d}_{32} & 0 & 0 \\ 0 & 0 & {d}_{22} & {d}_{21} \\ 0 & 0 & {d}_{42} & {d}_{41}\end{matrix} ] [ \begin{matrix}{s}_{11} & {s}_{12} & {s}_{13} & {s}_{14} \\ {s}_{21} & {s}_{22} & {s}_{23} & {s}_{24} \\ {s}_{31} & {s}_{32} & {s}_{33} & {s}_{34} \\ {s}_{41} & {s}_{42} & {s}_{43} & {s}_{44}\end{matrix} ] \qquad ( 4 )$$

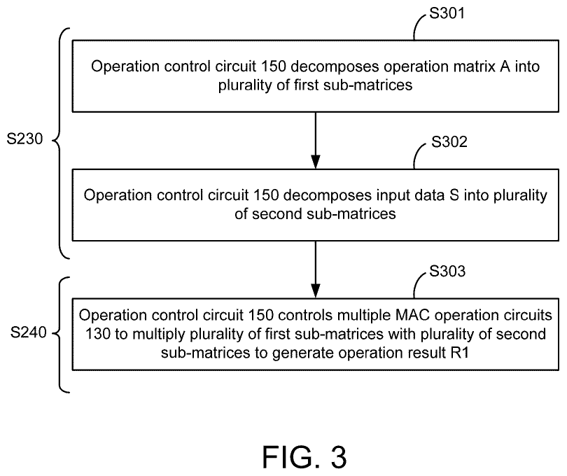

FIG. 3 shows a flowchart of operation S230 and operation S240 in FIG. 2 according to some embodiments of the present application. Operation S230 includes step S301 and step S302, and operation S240 includes step S303. In step S301, the operation control circuit 150 decomposes the operation matrix A into a plurality of first sub-matrices. In step S302, the operation control circuit 150 decomposes the input data S into a plurality of second sub-matrices. In step S303, the operation control circuit 150 controls the plurality of multiply-accumulate operation circuits 130 to multiply the plurality of first sub-matrices and the plurality of second sub-matrices to generate the operation result R1.

In continuation of the example above, in this example, the operation matrix A has a rather low number of dimensions, and may be completely decomposed into 2×2 matrix multiplication in diagonals. Thus, the operation control circuit 150 may further decompose the operation matrix A in equation (4) into equations below:

$$[ \begin{matrix}{t}_{11} & {t}_{12} \\ {t}_{21} & {t}_{22}\end{matrix} ] = [ \begin{matrix}{d}_{11} & {d}_{12} \\ {d}_{31} & {d}_{32}\end{matrix} ] [ \begin{matrix}{s}_{11} & {s}_{12} \\ {s}_{21} & {s}_{22}\end{matrix} ]$$

$$[ \begin{matrix}{t}_{13} & {t}_{14} \\ {t}_{23} & {t}_{24}\end{matrix} ] = [ \begin{matrix}{d}_{11} & {d}_{11} \\ {d}_{31} & {d}_{32}\end{matrix} ] [ \begin{matrix}{s}_{13} & {s}_{14} \\ {s}_{23} & {s}_{24}\end{matrix} ]$$

$$[ \begin{matrix}{t}_{31} & {t}_{32} \\ {t}_{41} & {t}_{42}\end{matrix} ] = [ \begin{matrix}{d}_{22} & {d}_{21} \\ {d}_{42} & {d}_{41}\end{matrix} ] [ \begin{matrix}{s}_{31} & {s}_{32} \\ {s}_{41} & {s}_{42}\end{matrix} ]$$

$$[ \begin{matrix}{t}_{33} & {t}_{34} \\ {t}_{43} & {t}_{44}\end{matrix} ] = [ \begin{matrix}{d}_{22} & {d}_{21} \\ {d}_{42} & {d}_{41}\end{matrix} ] [ \begin{matrix}{s}_{33} & {s}_{34} \\ {s}_{43} & {s}_{44}\end{matrix} ]$$

In the equations above, the four sub-matrices respectively formed by multiple elements d₁₁, d₃₁, d₃₂, d₂₁, d₂₂, d₄₁ and d₄₂ in the operation matrix Aare the first sub-matrices above, and the four sub-matrices respectively formed by multiple elements s₁₁, s₁₂, s₁₃, s₁₄, s₂₁, s₂₂, s₂₃, s₂₄, s₃₁, s₃₂, s₃₃, s₃₄, s₄₁, s₄₂, s₄₃ and s₄₄ in the input data S are the second sub-matrices above.

It is known from the equation above that, if the discrete cosine transform processing device 100 includes only one available multiply-accumulate operation circuit 130, the operation control circuit 150 may consecutively call this available multiply-accumulate operation circuit 130 to perform the operation of the equation above four times to generate the operation result R1 (equivalent to obtaining T in equation (4)). If the discrete cosine transform processing device 100 includes four or more available multiply-accumulate operation circuits 130, the operation control circuit 150 may simultaneously call four of the multiply-accumulate operation circuits 130 to perform the operation of the equation above at a time to directly generate the operation result R1. Similarly, if the discrete cosine transform processing device 100 includes two available multiply-accumulate operation circuits 130, the operation control circuit 150 may consecutively call the two multiply-accumulate operation circuits 130 to perform the operation of the equation above twice to generate the operation result R1.

Lastly, in operation S260, the output circuit 160 may perform the remaining operations in equation (3), that is, processing the operation result R1 based on the permutation matrix Pₗ to generate the operation result R2 (equivalent to Y in equation (3)), and this may be expressed as below:

$$Y = {P}_{l} \times T = [ \begin{matrix}{y}_{11} & {y}_{12} & {y}_{13} & {y}_{14} \\ {y}_{21} & {y}_{22} & {y}_{23} & {y}_{24} \\ {y}_{31} & {y}_{32} & {y}_{33} & {y}_{34} \\ {y}_{41} & {y}_{42} & {y}_{43} & {y}_{44}\end{matrix} ] = [ \begin{matrix}1 & 0 & 0 & 0 \\ 0 & 0 & 1 & 0 \\ 0 & 1 & 0 & 0 \\ 0 & 0 & 0 & 1\end{matrix} ] [ \begin{matrix}{t}_{11} & {t}_{12} & {t}_{13} & {t}_{14} \\ {t}_{21} & {t}_{22} & {t}_{23} & {t}_{24} \\ {t}_{31} & {t}_{32} & {t}_{33} & {t}_{34} \\ {t}_{41} & {t}_{42} & {t}_{43} & {t}_{44}\end{matrix} ] = [ \begin{matrix}{t}_{11} & {t}_{12} & {t}_{13} & {t}_{14} \\ {t}_{31} & {t}_{32} & {t}_{33} & {t}_{34} \\ {t}_{21} & {t}_{22} & {t}_{23} & {t}_{24} \\ {t}_{41} & {t}_{42} & {t}_{43} & {t}_{44}\end{matrix} ]$$

As described above, in some embodiments, the output circuit 160 may include a buffer and a controller, wherein the controller may write multiple elements in the matrix T in the equation above to the buffer based on a sequence the first Row, the second Row, the third Row and the fourth Row of the permutation matrix Pₗ, and output these elements as the matrix Y (equivalent to the operation result R2) based on the same sequence. Alternatively, in some other embodiments, the output circuit 160 may be an adder (or a multiplier), which may multiply the permutation matrix Pₗ by the matrix T to obtain the matrix Y.

On the basis of the operation matrix A of the attachment and the example above, a general formula for decomposing the operation matrix A based on equation (4) can be deduced as follows:

$$T = A \times S = [ \begin{matrix}{T}_{u} \\ {T}_{L} \\ {T}_{2 L} \\ ⋮ \\ {T}_{N / 2}\end{matrix} ] = [ \begin{matrix}{A}_{lu} & {0}_{L \times L} & {0}_{L \times 2 L} & ⋯ & {0}_{L \times \frac{N}{2}} \\ {0}_{L \times L} & {A}_{L \times L} & {0}_{L \times 2 L} & ⋯ & {0}_{L \times \frac{N}{2}} \\ {0}_{2 L \times L} & {0}_{2 L \times L} & {A}_{2 L \times 2 L} & ⋯ & {0}_{2 L \times \frac{N}{2}} \\ ⋮ & ⋮ & ⋮ & ⋱ & ⋮ \\ {0}_{\frac{N}{2} \times L} & {0}_{\frac{N}{2} \times L} & {0}_{\frac{N}{2} \times 2 L} & ⋯ & {A}_{\frac{N}{2} \times \frac{N}{2}}\end{matrix} ] [ \begin{matrix}{S}_{u} \\ {S}_{L} \\ {S}_{2 L} \\ ⋮ \\ {S}_{N / 2}\end{matrix} ]$$

Wherein, any matrix operation having a high dimension may be further decomposed into a matrix multiplication operation corresponding to the unit dimension.

For example, matrix multiplication having a dimension of 2L may be decomposed into four matrix multiplication operations having a dimension of L and two matrix accumulation operations:

$${T}_{2 L} = {A}_{2 L \times 2 L} \times {S}_{2 L} = [ \begin{matrix}{A}_{L \times L}^{11} & {A}_{L \times L}^{12} \\ {A}_{L \times L}^{21} & {A}_{L \times L}^{22}\end{matrix} ] [ \begin{matrix}{S}_{L}^{1} \\ {S}_{L}^{2}\end{matrix} ] = [ \begin{matrix}{A}_{L \times L}^{11} {S}_{L}^{1} + {A}_{L \times L}^{12} {S}_{L}^{2} \\ {A}_{L \times L}^{21} {S}_{L}^{1} + {A}_{L \times L}^{22} {S}_{L}^{2}\end{matrix} ]$$

Similarly, matrix multiplication having a dimension of 4L may first be decomposed into matrix multiplication having a dimension of 2L, and then eventually decomposed into multiple matrix multiplication operations having a dimension of L and matrix accumulation operations:

$${T}_{4 L} = {A}_{4 L \times 4 L} \times {S}_{4 L} = [ \begin{matrix}{A}_{2 L \times 2 L}^{11} & {A}_{2 L \times 2 L}^{12} \\ {A}_{2 L \times 2 L}^{21} & {A}_{2 L \times 2 L}^{22}\end{matrix} ] [ \begin{matrix}{S}_{2 L}^{1} \\ {S}_{2 L}^{2}\end{matrix} ] = [ \begin{matrix}{A}_{2 L \times 2 L}^{11} {S}_{2 L}^{1} + {A}_{2 L \times 2 L}^{12} {S}_{2 L}^{2} \\ {A}_{2 L \times 2 L}^{21} {S}_{2 L}^{1} + {A}_{2 L \times 2 L}^{22} {S}_{2 L}^{2}\end{matrix} ]$$

Thus, the operation control circuit 150 may decompose the matrix A with the approach above, and call the multiply-accumulate operation circuit 130 corresponding to the unit dimension to perform the operations of equation (4) to obtain the operation result R1.

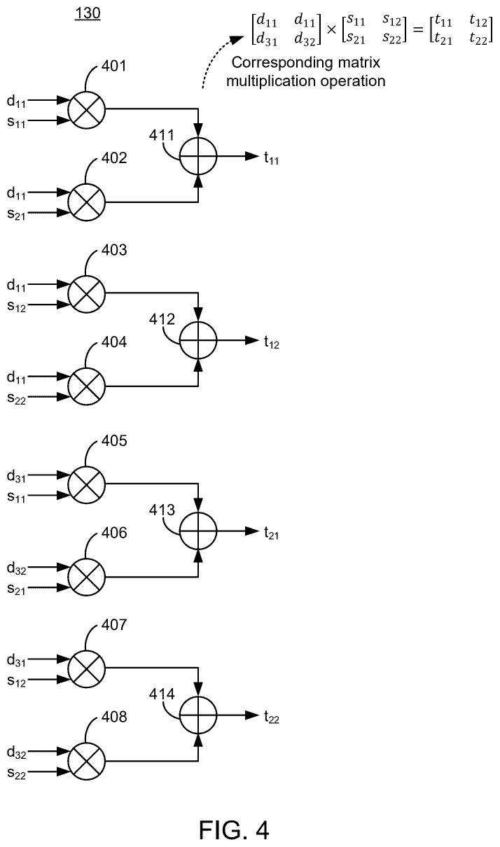

FIG. 4 shows a schematic diagram of the multiply-accumulate operation circuits 130 in FIG. 1 according to some embodiments of the present application. Taking the plurality of first and second sub-matrices decomposed on the basis of equation (4) for example, the multiply-accumulate operation circuit 130 may include a plurality of multipliers 401 to 408 and a plurality of adders 411 to 414. The multiplier 401 is configured for multiplying the element d₁₁ with the element s₁₁, the multiplier 402 configured is for multiplying the element d₁₁ with the element s₂₁, and the adder 411 configured is for adding the output of the multiplier 401 and the output of the multiplier 402 to generate an element t₁₁. The multiplier 403 is configured for multiplying the element d₁₁ with the element s₁₂, the multiplier 404 configured is for multiplying the element d₁₁ with the element s₂₂, and the adder 412 is configured for adding the output of the multiplier 403 and the output of the multiplier 404 to generate an element t₁₂. The multiplier 405 is configured for multiplying the element d₃₁ with the element s₁₁, the multiplier 406 is configured for multiplying the element d₃₂ with the element s₂₁, and the adder 413 is configured for adding the output of the multiplier 405 and the output of the multiplier 406 to generate an element t₂₁. The multiplier 407 is configured for multiplying the element d₃₁ with the element s₁₂, the multiplier 408 is configured for multiplying the element d₃₂ with the element s₂₂, and the adder 414 is configured for adding the output of the multiplier 407 and the output of the multiplier 408 to generate an element t₂₂. It should be understood that, the multiply-accumulate operation circuit 130 in FIG. 4 is configured as a basic circuit unit for performing 2×2 matrix multiplication; however, the present application is not limited to the example above.

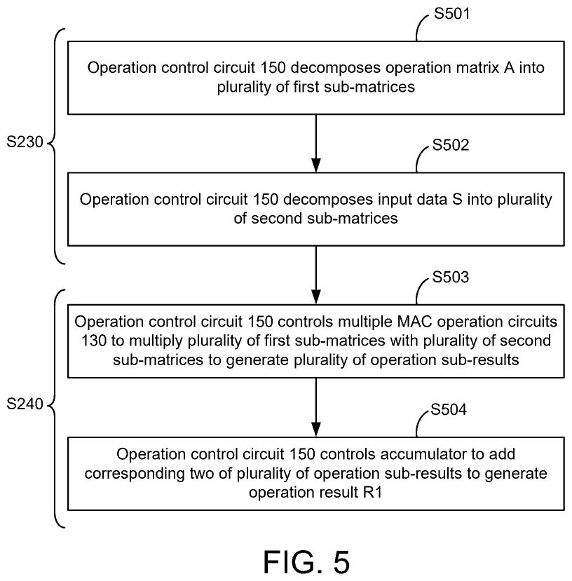

FIG. 5 shows a flowchart of operation S230 and operation S240 in FIG. 2 according to some embodiments of the present application. Operation S230 includes step S501 and step S502, and operation S240 includes step S503 and step S504. In step S501, the operation control circuit 150 decomposes the operation matrix A into a plurality of first sub-matrices. In step S502, the operation control circuit 150 decomposes the input data S into a plurality of second sub-matrices. In step S503, the operation control circuit 150 controls the plurality of multiply-accumulate operation circuits 130 to multiply the plurality of first sub-matrices and the plurality of second sub-matrices to generate a plurality of operation sub-results. In step S504, the operation control circuit 150 control the accumulator 140 to add corresponding two of the plurality of operation sub-results to generate the operation result R1.

Different from the example in FIG. 3, in this example, the operation matrix A has a higher number of dimensions, and thus cannot be completely decomposed into 2×2 matrix multiplication with diagonals. For example, in this case, equation (4) may be rewritten as below:

$$T = [ \begin{matrix}{t}_{11} & {t}_{12} & {t}_{13} & {t}_{14} \\ {t}_{21} & {t}_{22} & {t}_{23} & {t}_{24} \\ {t}_{31} & {t}_{32} & {t}_{33} & {t}_{34} \\ {t}_{41} & {t}_{42} & {t}_{43} & {t}_{44}\end{matrix} ] = A \times S = [ \begin{matrix}{d}_{11} & {d}_{12} & {d}_{13} & {d}_{14} \\ {d}_{21} & {d}_{22} & {d}_{23} & {d}_{24} \\ {d}_{31} & {d}_{32} & {d}_{33} & {d}_{34} \\ {d}_{41} & {d}_{42} & {d}_{43} & {d}_{44}\end{matrix} ] [ \begin{matrix}{s}_{11} & {s}_{12} & {s}_{13} & {s}_{14} \\ {s}_{21} & {s}_{22} & {s}_{23} & {s}_{24} \\ {s}_{31} & {s}_{32} & {s}_{33} & {s}_{34} \\ {s}_{41} & {s}_{42} & {s}_{43} & {s}_{44}\end{matrix} ]$$

In this case, the operation control circuit 150 may decompose the equation above as below:

$$[ \begin{matrix}{t}_{11} & {t}_{12} \\ {t}_{21} & {t}_{22}\end{matrix} ] = [ \begin{matrix}{d}_{11} & {d}_{12} \\ {d}_{21} & {d}_{22}\end{matrix} ] [ \begin{matrix}{s}_{11} & {s}_{12} \\ {s}_{21} & {s}_{22}\end{matrix} ] + [ \begin{matrix}{d}_{13} & {d}_{14} \\ {d}_{23} & {d}_{24}\end{matrix} ] [ \begin{matrix}{s}_{31} & {s}_{32} \\ {s}_{41} & {s}_{42}\end{matrix} ]$$

$$[ \begin{matrix}{t}_{13} & {t}_{14} \\ {t}_{23} & {t}_{24}\end{matrix} ] = [ \begin{matrix}{d}_{11} & {d}_{12} \\ {d}_{21} & {d}_{22}\end{matrix} ] [ \begin{matrix}{s}_{13} & {s}_{14} \\ {s}_{23} & {s}_{24}\end{matrix} ] + [ \begin{matrix}{d}_{13} & {d}_{14} \\ {d}_{23} & {d}_{24}\end{matrix} ] [ \begin{matrix}{s}_{33} & {s}_{34} \\ {s}_{43} & {s}_{44}\end{matrix} ]$$

$$[ \begin{matrix}{t}_{31} & {t}_{32} \\ {t}_{41} & {t}_{42}\end{matrix} ] = [ \begin{matrix}{d}_{31} & {d}_{32} \\ {d}_{41} & {d}_{42}\end{matrix} ] [ \begin{matrix}{s}_{11} & {s}_{12} \\ {s}_{21} & {s}_{22}\end{matrix} ] + [ \begin{matrix}{d}_{33} & {d}_{34} \\ {d}_{43} & {d}_{44}\end{matrix} ] [ \begin{matrix}{s}_{31} & {s}_{32} \\ {s}_{41} & {s}_{42}\end{matrix} ]$$

$$[ \begin{matrix}{t}_{33} & {t}_{34} \\ {t}_{43} & {t}_{44}\end{matrix} ] = [ \begin{matrix}{d}_{31} & {d}_{32} \\ {d}_{41} & {d}_{42}\end{matrix} ] [ \begin{matrix}{s}_{13} & {s}_{14} \\ {s}_{23} & {s}_{24}\end{matrix} ] + [ \begin{matrix}{d}_{33} & {d}_{34} \\ {d}_{43} & {d}_{44}\end{matrix} ] [ \begin{matrix}{s}_{33} & {s}_{34} \\ {s}_{43} & {s}_{44}\end{matrix} ]$$

Thus, the operation control circuit 150 may control the plurality of multiply-accumulate operation circuits 130 to sequentially perform the plurality of matrix multiplication operations in the equation above to generate a plurality of operation sub-results, and control the accumulator 140 to add corresponding two of the plurality of operation sub-results to generate the operation result R1 (equivalent to obtaining a plurality of elements in the matrix T).

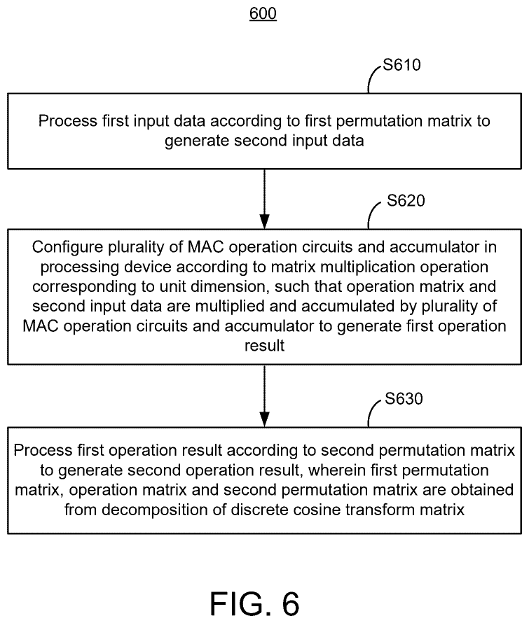

FIG. 6 shows a flowchart of a discrete cosine transform processing method 600 according to some embodiments of the present application. In some embodiments, the discrete cosine transform processing method 600 may be performed by a processing device (which may be, for example but not limited to, the discrete cosine transform processing device 100 in FIG. 1).

In operation S610, first input data is processed based on a first permutation matrix to generate second input data. In operation S610, a plurality of multiply-accumulate operation circuits and an accumulator in the processing device are configured according to a matrix multiplication operation corresponding to a unit dimension, such that an operation matrix and the second input data are multiplied by the plurality of multiply-accumulate operation circuits and the accumulator to generate a first operation result. In operation S630, the first operation result is processed based on a second permutation matrix to generate a second operation result, wherein the first permutation matrix, the operation matrix, and the second permutation matrix are derived from decomposition of a discrete cosine transform matrix.

Details associated with the multiple operations of the discrete cosine transform processing method 600 above can be referred from the details of the multiple embodiments above, and such repeated details are omitted herein. The multiple operations above are merely examples, and are not limited to being performed in the order specified in this example. Without departing from the operation means and ranges of the various embodiments of the present application, additions, replacements, substitutions or omissions may be made to the operations, or the operations may be performed in different orders.

In conclusion, the discrete cosine transform processing device and method provided according to some embodiments of the present application, by means of decomposition of a discrete cosine transform matrix into an operation matrix and a plurality of permutation matrices, are able to use simple circuits such as adders to implement multiplication of the permutation matrices above, hence reducing overall circuit costs and enhancing utilization efficiency of multipliers in hardware as well as further improving processing efficiency of discrete cosine transform.

While the present application has been described by way of example and in terms of the preferred embodiments, it is to be understood that the disclosure is not limited thereto. Various modifications may be made to the technical features of the present application by a person skilled in the art on the basis of the explicit or implicit disclosures of the present application. The scope of the appended claims of the present application therefore should be accorded with the broadest interpretation so as to encompass all such modifications.

Attachment: Algorithm for determining operation matrices A, permutation matrix Pᵣ and permutation matrix Pₗ, with calculation process as below.

```
Pₗ = 0_{N×N}
Pᵣ = 0_{N×N}
for i = 0, 1, ... , L − 1
  Pᵣ(i, i) = 1
  ${P}_{l} ( \frac{iN}{L} , i ) = 1$
end
for m = log₂ (L) to log₂(N) − 1, do
  n = 2^{m}
  for i = 0, 1, ... , n − 1
    ${P}_{l} ( \frac{iN}{n} + \frac{N}{2 n} , n + i ) = 1$
    Pᵣ(n + i, n + i) = − 1
    Pᵣ(n + i, n − i − 1) = 1
    for j = 0, 1, ... n − 1
      Pᵣ(j, n + i) = Pᵣ(j, n − i − 1)
    end
  end
end
    $A = {P}_{l}^{- 1} {DP}_{r}^{- 1} = [ \begin{matrix}{A}_{lu} & {0}_{L \times L} & {0}_{L \times 2 L} & ⋯ & {0}_{L \times \frac{N}{2}} \\ {0}_{L \times L} & {A}_{L \times L} & {0}_{L \times 2 L} & ⋯ & {0}_{L \times \frac{N}{2}} \\ {0}_{2 L \times L} & {0}_{2 L \times L} & {A}_{2 L \times 2 L} & ⋯ & {0}_{2 L \times \frac{N}{2}} \\ ⋮ & ⋮ & ⋮ & ⋱ & ⋮ \\ {0}_{\frac{N}{2} \times L} & {0}_{\frac{N}{2} \times L} & {0}_{\frac{N}{2} \times L} & ⋯ & {A}_{\frac{N}{2} \times \frac{N}{2}}\end{matrix} ]$
```

Wherein, θ_{m×n} is a zero matrix in m×n dimensions (that is, all elements are 0), A_{m×n} is a sub-matrix in m×n dimensions, A_{m×n}(i, j) is an element at the i^{th} row and the j^{th} column of the matrix, and A⁻¹ represents an inverse matrix of the matrix A.

What is claimed is:

1. A discrete cosine transform processing device, comprising:
an adder, processing first input data based on a first permutation matrix to generate second input data;
a register, storing an operation matrix;
a plurality of multiply-accumulate (MAC) operation circuits;
an accumulator;
an operation control circuit, configuring the plurality of multiply-accumulate operation circuits and the accumulator according to a matrix multiplication operation corresponding to a unit dimension, such that the operation matrix and the second input data are multiplied and accumulated by the plurality of multiply-accumulate operation circuits and the accumulator to generate a first operation result; and
an output circuit, processing the first operation result based on a second permutation matrix to generate a second operation result,
wherein the first permutation matrix, the operation matrix, and the second permutation matrix are derived from decomposition of a discrete cosine transform matrix.

2. The discrete cosine transform processing device according to claim 1, further comprising:
a selection circuit, selecting the operation matrix based on the number of dimensions of the first input data.

3. The discrete cosine transform processing device according to claim 1, wherein a product of the first permutation matrix, the operation matrix, and the second permutation matrix is the discrete cosine transform matrix.

4. The discrete cosine transform processing device according to claim 1, wherein the operation control circuit decomposes the operation matrix into a plurality of first sub-matrices, decomposes the second input data into a plurality of second sub-matrices, and controls the plurality of multiply-accumulate operation circuits to multiply the plurality of first sub-matrices by the plurality of second sub-matrices to generate the first operation result.

5. The discrete cosine transform processing device according to claim 1, wherein the operation control circuit decomposes the operation matrix into a plurality of first sub-matrices, decomposes the second input data into a plurality of second sub-matrices, controls the plurality of multiply-accumulate operation circuits to multiply the plurality of first sub-matrices by the plurality of second sub-matrices to generate a plurality of operation sub-results, and controls the accumulator to add corresponding two of the plurality of operation sub-results to generate the first operation result.

6. The discrete cosine transform processing device according to claim 1, wherein all elements in the first permutation matrix are valued merely 0, 1 or −1.

7. The discrete cosine transform processing device according to claim 1, wherein all elements in the second permutation matrix are valued merely 0 or 1.

8. A discrete cosine transform processing method, performed by a processing device, the discrete cosine transform processing method comprising:
processing first input data based on a first permutation matrix to generate second input data;
configuring a plurality of multiply-accumulate operation circuits and an accumulator in the processing device according to a matrix multiplication operation corresponding to a unit dimension, such that an operation matrix and the second input data are multiplied and accumulated by the plurality of multiply-accumulate operation circuits and the accumulator to generate a first operation result; and
processing the first operation result based on a second permutation matrix to generate a second operation result,
wherein the first permutation matrix, the operation matrix, and the second permutation matrix are derived from decomposition of a discrete cosine transform matrix.

9. The discrete cosine transform processing method according to claim 8, further comprising:
selecting the operation matrix based on the number of dimensions of the first input data.

10. The discrete cosine transform processing method according to claim 8, wherein a product of the first permutation matrix, the operation matrix, and the second permutation matrix is the discrete cosine transform matrix.
